(19) United States
(12) Patent Application Publication
(10) Pub. No.: US 2007/0115603 A1
(43) Pub. Date: May 24, 2007

(54) Demagnetization method by way of alternating current impulses in a conductor loop put in loops

(76) Inventor: Albert Maurer, Grut (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/601,087

(22) Filed: Nov. 17, 2006

(30) Foreign Application Priority Data
Nov. 24, 2005 (CH) CH 1875/05

(51) Int. Cl. H01H 47/00

(52) U.S. Cl. 361/149

(57) ABSTRACT

A method for the reproducible, capacitor-free demagnetization of objects with residual magnetism by way of at least one low-frequency and frequency-modulated alternating current impulse (1) of variable amplitude and alternating current impulse width (2) in a flexible, completely insulated, unshielded conductor is suggested, by which means a magnetic field impulse is created in the proximity of the conductor. A current control (24) with an inverter (20), a current sensor (22) and a closed control circuit produces the alternating current impulse (1) as a chain of individual demagnetization impulses (5) with a settable alternating current impulse frequency (4) and demagnetization impulse amplitude (6). The demagnetization impulse amplitude (6) is controlled with a closed loop to zero along a demagnetization curve (7), by which means the objects (30) in the vicinity of the conductor which may be applied into any shaped conductor loop (29), are demagnetized.

### FIELD OF THE INVENTION

The present invention describes a method for the reproducible, capacitor-free demagnetization of objects with a residual magnetism, by way of at least one low-frequency and frequency-modulated alternating current impulse of variable amplitude and alternating current impulse width, in a conductor, by which means a magnetic field impulse is produced in the vicinity of the conductor.

The objects may be ferromagnetic parts of different size and different weight. Thereby, the residual magnetism may result during the manufacture or treatment due to the influence of an outer magnetic field, but also may be impressed onto an object in a targeted manner.

### BACKGROUND OF THE INVENTION

Several methods are known for the demagnetization of ferromagnetic objects. Already earlier, the discharge of a charged capacitor of an oscillation circuit was utilized for demagnetization, wherein the magnetic alternating field on objects in the proximity of the demagnetization coil of the oscillation circuit occurring with the oscillating discharge of the capacitor is utilized. The disadvantage of this capacitor discharge method lies in the absent reproducibility of the magnetic alternating field and in the very rapidly decaying current impulse. A varying alternating field impulse results depending on the induction of the applied coil and on the other applied components, and one may no longer influence this, since it is influenced by the parameters of the oscillation circuit and is not controlled externally.

A further developed method for demagnetizing is described in U.S. Pat. No. 4,384,313, which again uses an oscillation circuit to which controlled alternating voltage impulses are applied. The mentioned oscillation circuit is controlled via a complex electronic construction, in that a rectifier rectifies the mains voltage, and by way of the direct voltage, supplies an inverter which supplies the oscillation circuit of one or more capacitors,and the demagnetization coil, with an alternating voltage of variable frequency and amplitude. Since it is the case of an oscillation circuit, the applied frequency of the alternating current which induces the magnetic alternating field is of great significance. The maximum current flow within the oscillation circuit and thus within the demagnetization coil may only be achieved when the phase shift between the applied voltage and the flowing current in the oscillation circuit is equal to zero. This phase shift only disappears when the inverter delivers an alternating voltage with the resonant frequency. The impedance, thus the alternating current resistance of the oscillation circuit is then minimal, and the maximum current and thus the maximally inducible magnetic field within the demagnetization coil occur. A phase detector is applied for the detection of the phase difference, in order to detect the phase shift between the voltage and the current. For this, the current signal is determined over the voltage which decays over a resistor in the oscillation circuit. An oscillator may set the applied inverter to the resonant frequency in a targeted manner by way of this phase information. The alternating current amplitude may be run down by the inverter when the described setting of the resonant frequency has taken place, by which means the demagnetization procedure is completed.

In a simpler embodiment, the phase detector is omitted and the frequency of the alternating current impulse is moved over a region which is smaller to greater that the resonant frequency. Thereby, the resonant frequency is in any case reached for a short while, with which the maximal possible magnetic alternating field occurs.

Since an alternating current impulse is used for demagnetization in an oscillation circuit, whose inductance is changed by the objects to be demagnetized, one must apply an electronic control which permits a setting of the alternating impulse frequency. If the resonant frequency is to be followed with a closed-loop control, apart from an electronic control which carries out the control of the alternating current impulse frequency, additionally a component must yet carry out the detection of the resonant frequency. One thus requires a complicated electronic construction in order to provide the alternating current impulse for producing an as large as possible magnetic alternating field impulse.

Since fixed coils are used, the geometric dimensions of the objects to be demagnetized are limited, since these must be brought into the proximity of the coils. The exact and compact as possible winding of the current cables in a coil has the disadvantage that they are greatly heated with large currents, and may lead to changed demagnetization curves in permanent operation. The applied capacitors also change their characteristics given a large formation of heat, which has an effect on the characteristics of the oscillation circuit.

EP 1465217 is referred to in order to obtain an insight as to how the objects to be demagnetized are arranged relative to the magnetic field. There, a transport line is described on which the objects are transported between a stationary, long coil or two stationary coils of an oscillation circuit, where the objects dwell for a desired time. Here too, the demagnetization is effected by an alternating current impulse which may be controlled in frequency and amplitude and whose alternating current impulse amplitude is reduced automatically from a maximal value to zero. During the demagnetization procedure, the objects are located in a homogeneous magnetic alternating field, whose field strength is reduced by the alternating current impulse amplitude. Here too, an inverter ensures the control of the current which flows through the oscillation circuit consisting of the two demagnetization coils and capacitors.

Since an oscillation circuit is also used here, the alternating current impulse frequency is to be tuned to the resonant frequency of the oscillation circuit, in order to achieve the maximal current flow in the oscillation circuit.

The disadvantage is that the size of the demagnetisable objects is determined by the diameter of the demagnetization coils. Likewise, the weight of the objects is limited by the carrying capacity of the transport line. Thus, a complete demagnetization of a large object, such as a turbine for example, as a whole is almost impossible, unless one provides a suitable transport line and coils of suitable diameter. Since however the complete demagnetization apparatus is so large and bulky that it must be installed into a production shop in a fixed manner, the disassembly and the transport of very large objects to the demagnetization device would be very cumbersome.

A device is also described in U.S. Pat. No. 4,360,854, in which the objects to be demagnetized are moved through coils of a large diameter so that the demagnetization may take place. Here, it is not possible to demagnetize large objects as a whole and in one step, despite the large dimensions of the coils. The size of the apparatus renders a mobile application of the demagnetization impossible. The objects to be demagnetized must be transported to the demagnetization device, in order there, lying on moveable transport vehicles, to be moved through the magnetic field of the coils. Particular demands are likewise made on the transport vehicles, which need to be designed for large weights. The described device necessarily demands the disassembly of components to be demagnetized, so that these may be led through the magnetic field. The machines and devices in which objects with residual magnetism are located are therefore to be decommissioned for a longer time so that the disassembly, the demagnetization and the renewed assembly may take place.

### SUMMARY OF THE INVENTION

It is the object of the present invention to provide a method which permits small to very large and heavy objects to be demagnetized in a reproducible manner, on-site and without disassembly. With this, one may avoid longer stoppage times of apparatus in which objects with residual magnetism which is to be removed, are located. The objects thus do not necessarily need to be removed for demagnetization. The present method requires no transport possibility of the objects with residual magnetism through transport lines or otherwise, which could lead to complications before and during the demagnetization. The dimensions of the demagnetisable objects are furthermore not limited by a premanufatured, possibly specially manufactured demagnetization coil. The method is transportable and may be applied in a small space without being tied to any location, on account of the few required components and the omission of bulky constructions.

The present method makes do without capacitors and thus without an electronic oscillation circuit, so that no resonant frequency detection and resonant frequency setting by way of further electronic components is necessary. In contrast to the oscillation circuit solutions, the present method achieves the object with selectable low frequencies from 1 Hz, which may not be achieved with the application of capacitors, or only with large demands on the capacitors. The avoidance of capacitors permits the superposition of a constant voltage component which may impress the object with a desired residual magnetism, onto the alternating current impulse. This is not possible with an oscillation circuit solution, since the capacitor blocks direct current and is charged.

### BRIEF DESCRIPTION OF THE DRAWINGS

The method and the device for achieving the above-described object is hereinafter described in combination with the drawings.

FIG. 1 shows an applied alternating current impulse in the I/t diagram, wherein only about 20 periods are drawn for the sake of a better overview.

FIG. 2 additionally shows an alternating current impulse to which a direct current component is additively superimposed.

FIG. 3 shows the current control with a few details, and the connection of the conductor whilst forming a few loops around the object, in a schematic representation

### DETAILED DESCRIPTION OF THE INVENTION

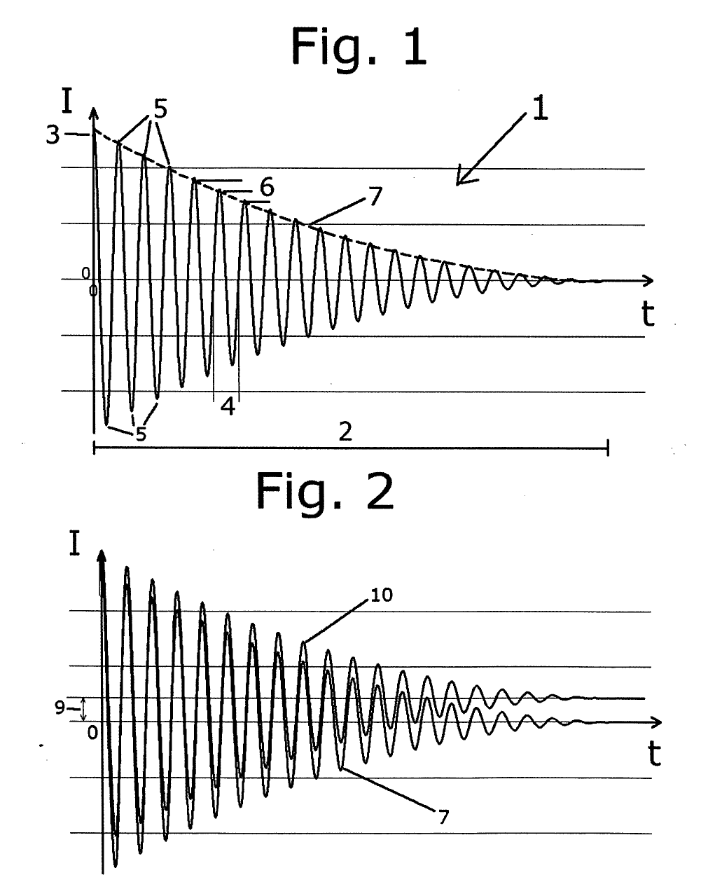

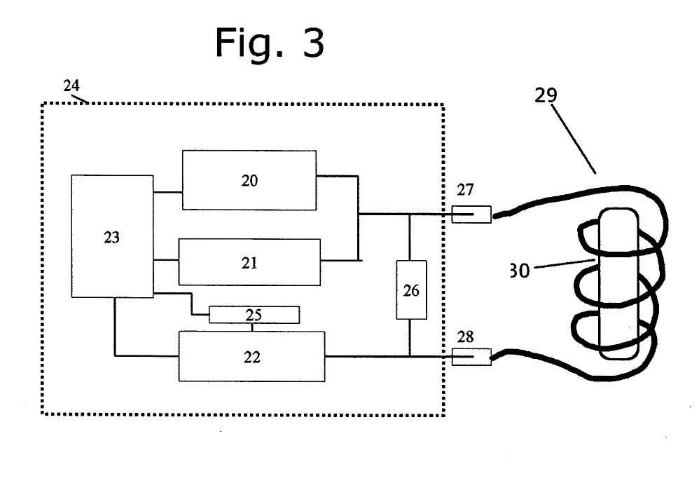

For demagnetizing components of differing thickness, one applies magnetic alternating fields which are produced by at least one alternating current impulse 1 with a settable alternating current impulse width 2. As is represented in FIG. 1, the alternating current impulse 1 consists of a chain of demagnetization impulses 5 of alternating polarity with controllable demagnetization impulse amplitudes 6. The polarity change of the demagnetization impulse 5 is effected with a settable alternating current impulse frequency 4. The alternating current impulse frequency 4 determines the penetration depth of the resulting magnetic field into the material to be demagnetized. Thereby, low alternating current impulse frequencies 4 of a few Hertz lead to large penetration depths. One operates with alternating current impulse frequencies 4 larger than 1 Hz in the present invention. Starting from an alternating current impulse amplitude maximum 3, the demagnetization impulse amplitudes 6 are continuously reduced towards zero with a controllable decrement. The envelope of the demagnetization impulse amplitudes 6 is hereinafter called the demagnetization curve 7. Measurements have shown that it is advantageous for the demagnetization curve 7 to drop in an as flat and thus slow as possible manner. The alternating current impulse width 2 is usually selected such that one runs through about 100 alternating current impulse periods with a demagnetization procedure. The alternating current impulse frequency 4 is selected according to the required penetration depth of the magnetic field, by which means the alternating current impulse width 2 and thus the total time of the complete demagnetization is determined.

Very high demands are set on the shape of the alternating current impulse 1 for the complete and reproducible demagnetization. On the one hand, it is absolutely necessary for the current zero point with each polarity change after each individual demagnetization impulse 5 to be passed through in a linear manner and without singularities. On the other hand, a high symmetry of the demagnetization impulses 5 must be achieved.

Thirdly, the exact and reproducible control of smaller demagnetization impulse amplitudes 6 in the already greatly decayed region of the demagnetization curve 7 is very important. One must therefore achieve a high current resolution. In the present invention, the alternating demagnetization impulse amplitudes 6 are controlled in a reproducible manner up to an amplitude of less than a thousandth of the alternating current impulse amplitude maximum 3.

The described demands on the shape of the demagnetization curve 7 are achieved by a current control 24 which is described in more detail in the following.

An inverter 20 in the current control 24 described here produces the low-frequency alternating current impulses 1 with the demands described above. This inverter 20 is constructed from transistors in a bridge circuit which operates with pulse width modulation. Today IGBT (insulated gate bipolar transistors) are used, since these have a high blocking voltage and may circuit large currents. However, other circuiting concepts, (for example with MOSFETS) are conceivable and implementable for the internal circuiting of the inverter 20.

The rectangular impulses of frequencies of greater than 3 kHz produced in the inverter are produced by transistors which exhibit no holding current effect. The high base frequency of the inverter 20 which is applied for impulse width modulation, permits the closed-loop control of alternating current impulses 1 from zero Hz (thus direct current) up to the mains frequency (50 Hz or 60 Hz) with a great precision. The current control 24 contains a current sensor 22 which may read out the actual flowing current, even with low demagnetization impulse amplitudes 6, by which means a closed current control circuit is controlled. The signals of the current sensor 22 are again fed into the inverter 20 via a programming- and read-out unit. Thus, the control of small demagnetization impulse amplitudes 6 of up to less than a thousandth of the alternating current impulse amplitude maximum 3 are to be achieved. The inverter-internal circuit furthermore ensures that the current zero point is passed through in an absolutely linear manner with each change in polarity, which is essential for a complete demagnetization.

The high inverter-internal frequency with regard to the immission limit values, with a mainly inductive load at the inverter, lies in a range in which a lower loss of power occurs with the production of the alternating current impulse 1, than with lower frequencies. This renders the use of an inverter 20 more effective than the use of other current sources. The current control 24 and thus the demagnetization curve 7 which is to be travelled along, the demagnetization impulse amplitudes 6 and the alternating current impulse frequency 4 are programmable via the programming- and read-out unit 23. This permits the parameters of the alternating current impulse 1 to be set by way of the connection of a computer to the current control 24 or by way of manual programming of the programming- and read-out unit 23.

For demagnetization, a flexible and completely insulated, unshielded conductor of an adequate length in the form of a known stranded cable is connected between an input 27 and an output 28 of the current control 24. Thereby, one should take care that the cable is designed for the highest voltage of the demagnetization and the alternating current impulse amplitude maximum 3. Since one operates with high currents and voltages, it is important for the conductor to be securely fastened to the current control 24 and for it not to be able to detach in an unintended manner. One possibility lies in a screw connection, wherein the plug of the conductor as well as the connection sockets 27, 28 of the current control 24 comprise threads.

A conductor monitoring 26 is used in order to ensure that the conductor is correctly cabled and an alternating current impulse 1 may flow. This measures the ohmic resistance between the input 27 and output 28 of the current control 24 in the unloaded condition, from which it is evident as to whether the conductor is correctly connected to the input 27 and output 28 of the current control 24 and whether the cable is in order. Only when the conductor is correctly connected, thus an ohmic resistance is measurable, can the alternating current impulse 1 be activated by the current control 24.

After the conductor has been connected to the current control 24, checked by the conductor monitoring 26, is it brought into the proximity of the object 30 to be demagnetized, so that the object 30 is positioned in the magnetic field which results with the later flow of current. One possibility lies in shaping the flexible conductor into a conductor loop 29 whose shape is variable. In order to ensure that the magnetic field penetrates the object 30, the conductor loop 29 may be applied around the object 30 in at least one loop. In advantageous embodiments of the conductor, this is selected so long that it may be applied around the object 30 in several loops or wound in a shaped manner. This forms the conductor loop core on forming multiple loops around the object 30.

A collection of objects 30 may also be demagnetized with one demagnetization procedure if the objects are filled for example into a bulk goods container which is enclosed by the conductor loop 29 with any number of windings.

A magnetic alternating field forms with the flow of the alternating current impulse 1 through the conductor, which due to the manner of the loop formation of the conductor, leads to a statistical, random field line distribution. The conductor heats up due to the occurring partly very high flow of current. One may optionally utilize the effect for the current flow monitoring 25. By way of the current flow monitoring 25, one may ascertain as to whether the alternating current impulse 1 has indeed flowed through the conductor. This current flow monitoring 25 is carried out with the help of a resistance measurement apparatus which reads out the momentary ohmic resistance of the condcutor and transmits it further to the programming- and read-out unit 23 during the demagnetization procedure. The temperature of the conductor increases due to the high current amplitudes of more than 100 A during the demagnetization impulses 5, which leads to an increased ohmic resistance. This current flow monitoring 25 thus provides a reading which indicates whether the current has flowed through the conductor. Furthermore, the determining of the temperature from the measured resistance value permits the protection of the conductor from temperature which are too high.

It is possible to additively superimpose a defined, constant and small direct current component on the alternating field on account of the use of a capacitor-free current circuit for the flow of alternating current impulses 1 through a flexible conductor loop. A direct current source 21 in the current control 24 may add the direct current component 9 already at the beginning of the alternating current impulse 1 or increase it is the course of the decaying demagnetization curve 7. Such a direct current component 9 superimposed on the alternating current impulse 1 serves for compensating the static magnetic field of the earth. Additionally, a desired magnetization may be impressed onto the treated object 30 by way of the superposition of a direct current component.

It is above all with simple and inexpensive inverters 20 that the possibility exists of lowering the demagnetization voltage from which the alternating current impulse results, and thus of reducing the demagnetization impulse amplitude. For this purpose, the mentioned inverters 20 have a function called the closed-loop controlled motor switch-off. The reproducibility of the demagnetization is not necessarily given by the reduction of the demagnetization voltage.

List of Reference Numerals

1 alternating current impulse
2 alternating current impulse width (envelope to 0)
3 alternating current impulse amplitude maximum
4 alternating current impulse frequency
5 demagnetization impulse
6 demagnetization impulse amplitude
7 demagnetization curve
8 conductor
9 direct current component
10 demagnetization curve with direct current component≠0
20 inverter
21 direct current source
22 current sensor
23 programming- and read-out unit
24 current control
25 current flow monitoring
26 conductor monitoring
27 input of the current control
28 output of the current control
29 conductor loop
30 object

1. A method for the reproducible, capacitor-free demagnetization of objects with a residual magnetism by way of at least one low-frequency and frequency-modulated alternating current impulse produced by a current control, of variable amplitude and alternating current impulse width, in a conductor which may be connected in a capacitor-free manner between the input and an output of the current control, by which means a magnetic field impulse is produced in the vicinity of the conductor, wherein the conductor is flexible, completely insulated, unshielded and plastically deformable, and whilst forming a conductor loop in any shape, is applied around an object to be demagnetized, whereupon the ends of the conductor loop are connected to the input and the output of the current control in a capacitor-free manner and
whereupon the alternating current impulse of individual, alternatingly poled and symmetrical demagnetization impulses with controlled demagnetization impulse amplitude and alternating current impulse frequency of greater than 1 Hz is fed in, wherein the temporal course of the demagnetization impulse amplitudes is emulated by a demagnetization curve decaying in a non-exponential manner, wherein the ratio of the smallest demagnetization impulse amplitude to the alternating current impulse amplitude maximum lies at least 1:1000 and the conductor loop is removed after completion of the demagnetization of an object.

2. A method according to claim 1, wherein the conductor loop with any number of windings is applied around the object to be demagnetized whilst forming at least one loop, wherein the object serves as a conductor loop core.

3. A method according to claim 1, wherein the conductor loop with any number of windings is applied around a bulk goods container, filled with objects to be demagnetized, whilst forming at least one loop, by which means several objects may be demagnetized with a demagnetization procedure.

4. A method according to claim 1, wherein the alternating current impulse width extends over at least 100 periods of the alternating current impulse frequency, wherein the demagnetization impulse amplitudes are reduced to zero along the demagnetization curve.

5. A method according to claim 1, wherein a controlled constant direct current component is additively superimposed on the alternating current impulse, said direct current component still being present after traveling along the demagnetization curve to a demagnetization impulse amplitude of zero, and a magnetic field is impressed into the treated object by way of this.

6. A method according to claim 1, wherein a conductor monitoring before the flow of the alternating current impulse measures and evaluates the ohmic resistance between the input and the output of the current control, whereupon the demagnetization procedure is only started in the case of a finite ohmic resistance.

7. A method according to claim 1, wherein a current flow monitoring reads out the ohmic resistance of the conductor during the travel along the demagnetization curve.

8. A method according to claim 7, wherein the temperature of the conductor during the demagnetization is determined from the result of the current flow monitoring.

9. A method according to claim 1, wherein the demagnetization impulse amplitudes and thus the demagnetization curve takes place by way of a reduction of the demagnetization voltage at the inverter by way of a closed-loop controlled motor switch-off.

10. A device for the reproducible, capacitor-free demagnetization of object with a residual magnetism, comprising a programmable current control, with which low-frequency and frequency-modulated alternating current impulses of variable amplitude and alternating current impulse width may be produced, a conductor which is connectable between the input and the output of the current control, for application of the method according to claim 1, wherein the conductor is a flexible, commercially available cable which is completely insulated, unshielded and is plastically deformable into any shaped conductor loop and may be applied around an object to be demagnetized with any number of windings.

11. A device according to claim 10, wherein the programmable current control comprises a current flow monitoring which reads out the ohmic resistance of the conductor during the travel along the demagnetization curve.

12. A device according to claim 11, wherein the temperature of the conductor may be determined during the demagnetization from the result of the current flow monitoring.

13. A method according to claim 2, wherein:
the alternating current impulse width extends over at least 100 periods of the alternating current impulse frequency, wherein the demagnetization impulse amplitudes are reduced to zero along the demagnetization curve;
a controlled constant direct current component is additively superimposed on the alternating current impulse, said direct current component still being present after traveling along the demagnetization curve to a demagnetization impulse amplitude of zero, and a magnetic field is impressed into the treated object by way of this;
a conductor monitoring before the flow of the alternating current impulse measures and evaluates the ohmic resistance between the input and the output of the current control, whereupon the demagnetization procedure is only started in the case of a finite ohmic resistance;
a current flow monitoring reads out the ohmic resistance of the conductor during the travel along the demagnetization curve;
the temperature of the conductor during the demagnetization is determined from the result of the current flow monitoring;
the demagnetization impulse amplitudes and thus the demagnetization curve takes place by way of a reduction of the demagnetization voltage at the inverter by way of a closed-loop controlled motor switch-off.

14. A method according to claim 3, wherein:
the alternating current impulse width extends over at least 100 periods of the alternating current impulse frequency, wherein the demagnetization impulse amplitudes are reduced to zero along the demagnetization curve;
a controlled constant direct current component is additively superimposed on the alternating current impulse, said direct current component still being present after traveling along the demagnetization curve to a demagnetization impulse amplitude of zero, and a magnetic field is impressed into the treated object by way of this;
a conductor monitoring before the flow of the alternating current impulse measures and evaluates the ohmic resistance between the input and the output of the current control, whereupon the demagnetization procedure is only started in the case of a finite ohmic resistance;
a current flow monitoring reads out the ohmic resistance of the conductor during the travel along the demagnetization curve;
the temperature of the conductor during the demagnetization is determined from the result of the current flow monitoring;
the demagnetization impulse amplitudes and thus the demagnetization curve takes place by way of a reduction of the demagnetization voltage at the inverter by way of a closed-loop controlled motor switch-off.

15. A device for the reproducible, capacitor-free demagnetization of object with a residual magnetism, comprising a programmable current control, with which low-frequency and frequency-modulated alternating current impulses of variable amplitude and alternating current impulse width may be produced, a conductor which is connectable between the input and the output of the current control, for application of the method according to claim 13, wherein:
the conductor is a flexible, commercially available cable which is completely insulated, unshielded and is plastically deformable into any shaped conductor loop and may be applied around an object to be demagnetized with any number of windings;
the programmable current control comprises a current flow monitoring which reads out the ohmic resistance of the conductor during the travel along the demagnetization curve; and
the temperature of the conductor may be determined during the demagnetization from the result of the current flow monitoring.

16. A device for the reproducible, capacitor-free demagnetization of object with a residual magnetism, comprising a programmable current control, with which low-frequency and frequency-modulated alternating current impulses of variable amplitude and alternating current impulse width may be produced, a conductor which is connectable between the input and the output of the current control, for application of the method according to claim 14, wherein:
the conductor is a flexible, commercially available cable which is completely insulated, unshielded and is plastically deformable into any shaped conductor loop and may be applied around an object to be demagnetized with any number of windings;
the programmable current control comprises a current flow monitoring which reads out the ohmic resistance of the conductor during the travel along the demagnetization curve; and
the temperature of the conductor may be determined during the demagnetization from the result of the current flow monitoring.
